(19) United States
(12) Patent Application Publication
(10) Pub. No.: US 2002/0023661 A1
(43) Pub. Date: Feb. 28, 2002

(54) Ultrasonic cleaning apparatus and method

(76) Inventor: Yuichi Yamamoto, Tsu-shi (JP)

Correspondence Address: Dike, Bronstein, Roberts & Cushman, Intellectual Property Practice Group, Edwards & Angell, LLP, 130 Water Street, Boston, MA, 02109, US

(21) Appl. No.: 09/935,522

(22) Filed: Aug. 23, 2001

(30) Foreign Application Priority Data
Aug. 25, 2000 (JP) P2000-256180

(51) Int. Cl. B08B 3/12

(52) U.S. Cl. 134/1

(57) ABSTRACT

Surfaces of a glass substrate to be cleaned is subjected to ultrasonic cleaning while being carried by a carrier roller by means of ultrasonic vibration units arranged in two rows in a widthwise direction. A plurality of ultrasonic vibration units are arranged in two rows in a staggered configuration so that a certain ultrasonic vibration unit of one row is located toward a substantially central portion of two adjacent ultrasonic vibration units of the other row. In each of the ultrasonic vibration units, a vibrator is attached to its respective vibration plate so as to pair up therewith. The vibration plate and the vibrator acting as a pair can be detached from the ultrasonic vibration unit simply by removing a bolt. This makes the maintenance easy and reduces the manufacturing cost.

### BACKGROUND OF THE INVENTION

1. Field of the Invention

The present invention relates to an ultrasonic cleaning apparatus and method for use in manufacturing processes of a semiconductor wafer, a liquid crystal display panel and the like.

2. Description of the Related Art

Conventionally, for a semiconductor wafer, a glass substrate for use with a liquid crystal display apparatus, and the like, there has been a demand for higher degree of purification. As methods for cleaning an LCD glass substrate or the like are known a dip method and a piece-by-piece method. In the former, a plurality of substrates to be cleaned are soaked in cleaning solution. In the latter, materials to be cleaned are cleaned on an individual basis by being sprayed with cleaning solution. Recently, the piece-by-piece method is coming into wider and wider use from the viewpoint of cleaning capability and cost. Of the piece-by-piece methods, a vibration method has been in practical use in which vibration method ultrasonic vibration is applied to cleaning solution which is sprayed to a material to be cleaned, and, by exploiting the action of vibration, fine particles attached to the material to be cleaned are removed. In this method, ultrasonic vibration having a frequency within a range of 20 kHz to 1.5 MHz is used. Ultrasonic vibration acts to weaken the binding force between the fine particles attached to the material to be cleaned. Thus, as compared with the case where no ultrasonic vibration is applied to cleaning solution, a higher cleaning effect can be attained. Prior art ultrasonic cleaning apparatuses for use in manufacturing processes of a liquid crystal display apparatus or a semiconductor apparatus are proposed in, for example, Japanese Unexamined Patent Publications JP-A 9-19664 (1997) and JP-A 9-192618 (1997).

FIGS. 4 to 6 illustrate the outline of the ultrasonic cleaning apparatus proposed in JP-A 9-19664, with FIG. 4 showing the longitudinal sectional configuration of the ultrasonic cleaning apparatus, FIG. 5 showing the section thereof taken along section lines A-A of FIG. 4, and FIG. 5 showing the same taken along section lines B-B of FIG. 4. The ultrasonic cleaning apparatus has an elongated apparatus body 111. The slim, prism-shaped apparatus body 111 is composed of an upper member 113 and a lower member 115. The upper member 113 has an upwardly-opened concave portion 112 which extends in its longitudinal direction. The lower member 115 is fluid-tightly bonded to the bottom surface of the upper member 113 with a first sealing member 114 therebetween. On the wall of the lower part of the upper member 113 is piercingly formed an engagement hole 116 which extends in the longitudinal direction. In the widthwise central portion of the top surface of the lower member 115 is formed a projection 117 which is engaged in the engagement hole 116.

The lower member 115 has, in its widthwise central portion where the projection 117 is formed, a space portion 118 extending in the longitudinal direction, the space portion 118 having its one end opened upwardly and having its other end opened downwardly. The section of the space portion 118 is taper-shaped, i.e., shaped such that its width dimension decreases gradually from one end to the other end. The lower-end opening serves as a narrow nozzle 119. The upwardly-opened end of the space portion 118 is fluid-tightly sealed with a vibration plate 121 made of a thin rectangular metal sheet. The vibration plate 121 is, at its lower perimeter, bonded to the inner bottom surface of the concave portion 112 of the upper member 113 via a frame-like second sealing member 122 having a predetermined thickness. The vibration plate 121 has on its top surface a frame-like holding plate 123 fixed to the upper member 113. In this way, the upper-end opening of the space portion 118 is air-tightly sealed.

In the widthwise central portion of the top surface of the vibration plate 121, i.e., the portion corresponding to the space portion 118, are disposed a plurality of vibrators 124 made of piezoelectric elements in the longitudinal direction of the vibration plate 121. Above the vibration plate 121 is disposed a power supply plate 125 which is attached to the holding plate 123 via a holding member 126. The power supply plate 125 is provided with a contact 127 which makes elastic contact with the vibrator 124. The power supply plate 125 is also provided with a coil 128, so that power is supplied from the coil 128 via the power supply plate 125 and the contact 127 to the vibrator 124. The supplying allows the vibrator 124 to ultrasonically vibrate, and, in synchronism with this vibration, the vibration plate 121 vibrates.

In the lower member 115 of the apparatus body 111 are formed a pair of longitudinally-penetrating supply paths 131 located on both widthwise sides of the space portion 118. Pure water or cleaning solution (such as chemical solution) is supplied via a tube to both ends of the supply paths 131. A plurality of jets 132 are spaced along the supply paths 131. Cleaning solution is sprayed from each of the jets 132 to the bottom surface of the vibration plate 121. The ultrasonic vibration exerted by the vibration plate 121 propagates through the cleaning solution applied to the bottom surface of the vibration plate 121. As indicated by arrows in FIG. 4, the cleaning solution to which ultrasonic vibration is transmitted flows through the space portion 118 and is ejected from the nozzle opening 119 provided at the lower end of the space portion 118. Thus, by opposedly placing materials to be cleaned on the underside of the nozzle opening 119, the materials to be cleaned can be cleaned with cleaning solution applied with ultrasonic vibration.

In the ultrasonic cleaning apparatus as shown in FIGS. 4 to 6, a plurality of vibrators 124 are attached relatively to the vibration plate 121 in the longitudinal direction. The ultrasonic intensity between the vibrators 124 adjacent to each other is low relative to that in the vibrator 124 per se. That is, in the longitudinal direction of the vibration plate 121, the ultrasonic intensity of the portions where the vibrators 124 exist is different from that in the portion therebetween. Thus, even if the vibration plate is arranged face to face with the surface of the material to be cleaned, due to variation in ultrasonic intensity occurring in the longitudinal direction of the vibration plate, the material to be cleaned cannot be cleaned evenly. This makes it impossible to attain steady productivity. Moreover, according to the applicant of the invention, in order to secure as wide an ultrasonic wave applied region as possible, i.e., to increase the number of the vibrators 124 to be attached, it is inevitable that the reliability of the apparatus is deteriorated.

The vibrator 124, taking on a rectangular shape, is statically polarized and has a gold (Au) or silver (Ag)-made electrode portion formed thereon. It is impossible for such rectangular-shaped vibrators 124 to be tightly arranged and fixed to the vibration plate 121 in view of thermal expansion occurring in the vibrator 124 and danger of short-circuit in the electrode portions of the vibrators 124 adjacent to each other. Thus, the vibrators 124 need to be arranged with a gap therebetween. However, since this gap has no sound source, in a case where a plurality of vibrators 124 are arranged in the longitudinal direction to form an ultrasonic wave applied region, it is inevitable that a portion exerting lower sound pressure with respect to the material to be cleaned linearly emerges in a direction in which the material to be cleaned is carried. This causes degradation of the cleaning effect.

Moreover, in general, a plurality of vibrators 124 are fixed to a single vibration plate 121 by bonding with use of heat-hardening resin, and therefore there arises a difference in thermal expansion ratio between the vibration plate 121 and the vibrators 124. This might cause, after the fixing is achieved, warpage, or damage to the vibrator 124. Further, since a plurality of vibrators 124 are all fixedly attached to the vibration plate 121, if even one of them suffers from a trouble, the vibration plate 121 as a whole needs to be replaced with a new one. This leads to undesirable increases in time required for maintenance and running cost.

### SUMMARY OF THE INVENTION

An object of the invention is to provide an ultrasonic cleaning apparatus and method offering sustainable reliability by which a material to be cleaned can be wholly cleaned with cleaning solution applied with a sufficiently high intensity ultrasonic wave.

The invention provides an ultrasonic cleaning apparatus in which ultrasonic vibration is applied to at least part of cleaning solution, and, by a piece-by-piece method, a material to be cleaned is cleaned with the cleaning solution while being carried in a predetermined direction, the ultrasonic cleaning apparatus comprising:

a plurality of ultrasonic vibration units each having a nozzle elongated in one direction, for spraying cleaning solution from the nozzle to the material to be cleaned, the cleaning solution being applied with ultrasonic vibration by a vibration plate to which a vibrator is fixed so as to pair up therewith, wherein the plural ultrasonic vibration units are arranged in two rows in a widthwise direction orthogonal to the carrying direction, and also so arranged that a certain ultrasonic vibration unit of one row is located toward a substantially center of two adjacent ultrasonic vibration units of the other row.

According to the invention, in the ultrasonic cleaning apparatus, ultrasonic vibration is applied to at least part of cleaning solution, and, by a piece-by-piece method, a material to be cleaned is cleaned with the cleaning solution while being carried in a predetermined direction. The cleaning solution applied with an ultrasonic wave is ejected from the nozzle elongated in one direction of the ultrasonic vibration unit. A plurality of ultrasonic vibration units are arranged in two rows in the widthwise direction orthogonal to the carrying direction, and also so arranged that a certain ultrasonic vibration unit of one row is located toward a substantially central portion of two adjacent ultrasonic vibration units of the other row. In each of the ultrasonic vibration units, the vibrator and the vibration plate are fixed to each other in a one-to-one relationship. By this arrangement, ultrasonic wave generated by the vibration plate is applied to the cleaning solution evenly. The surface of the material to be cleaned is sprayed with cleaning solution applied with ultrasonic wave ejected from the nozzles of the ultrasonic vibration units arranged in two rows in a direction orthogonal to the carrying direction. More specifically, the material receives cleaning solution ejected from the nozzles of the two rows of ultrasonic vibration units which are arranged in the widthwise direction so as to be displaced in relation to one another, so that the entire widthwise surface of the material to be cleaned is sprayed with a jet of cleaning solution applied with ultrasonic wave. As a result, the material can be cleaned thoroughly. Further, in each of the ultrasonic vibration units, since the vibrator and the single vibration plate are fixed to each other so as to act as a pair, if one vibrator suffers from a trouble, it is essential only that its corresponding vibration plate is replaced. This makes it possible to realize a construction with sustainable reliability.

As described heretofore, according to the invention, a sufficient amount of cleaning solution applied with an ultrasonic wave is sprayed to all over the material which is cleaned by a piece-by-piece method, thereby making the cleaning effect stable. Moreover, in each of the plural ultrasonic vibration units, since the vibrator and the vibration plate are fixed to each other so as to act as a pair, if one vibrator suffers from a trouble, it is essential only that its corresponding vibration plate is replaced. This helps make the maintenance easy and reduce the running cost. As a result, the reliability is sustained with ease.

In the invention, it is preferable that the ultrasonic vibration unit includes:

a holding member for holding the vibrator;

a power supply member for supplying a high frequency power to the vibrator by making elastic contact with an electrode of the vibrator and the holding member;

a wire for supplying the power to the power supply member; and

a casing having an enclosed space portion formed therein for accommodating the vibrator, the power supply member, and the wire, and

wherein the nozzle with a predetermined dimensional width is disposed adjacent to the vibration plate, the nozzle including a projection piece for supplying cleaning solution through which ultrasonic vibration is transmitted to the vibration plate and for convectively circulating the cleaning solution.

According to the invention, the enclosed space portion of the casing accommodates the vibrator, the power supply member, and the wire. Power is supplied to the vibrator so as to generate an ultrasonic vibration, so that the vibration plate gives an ultrasonic wave to the cleaning solution with stability. The cleaning solution to which ultrasonic wave is transmitted by the vibration plate convectively flows by dint of the projection piece included in the nozzle. This allows the cleaning solution applied with an ultrasonic wave to be sprayed from the nozzle to the material to be cleaned with efficiency.

Moreover, according to the invention, power supply to the vibrator is performed in the enclosed space portion provided within the casing, so that an ultrasonic wave is generated with stability.

In the invention, it is preferable that, in each of the ultrasonic vibration units arranged, the casing includes:

a cleaning solution supply path for supplying cleaning solution to the nozzle;

an air supply path for supplying air to the enclosed space portion; and

a wire-laying path for laying down the wire required to supply the power to the vibrator.

According to the invention, the casing is provided with the cleaning solution supply path, the air supply path, and the wire-laying path. Since the air supply path supplies air to an enclosed space, within the enclosed space, the reliability of the section for power supply to the vibrator improves.

Moreover, according to the invention, the enclosed space portion is supplied with air by the air supply path, so that the reliability of the section for power supply to the vibrator improves.

In the invention, it is preferable that, in each of the ultrasonic vibration units, the casing is provided with an opening portion for providing communication among the enclosed space portion, the air supply path, and the wire-laying path, and by circulating inert gas or dry air, the power supply member, the wire, and the vibrator are put under inert gas atmosphere or dry air atmosphere.

According to the invention, in each of the ultrasonic vibration units, the casing is provided with an opening portion for providing communication among the enclosed space portion, the air supply path, and the wire-laying path. Thus, inert gas or dry air can circulate through the enclosed space portion, thereby putting the power supply member, the wire, and the vibrator under the protection of the inert gas atmosphere or dry air atmosphere. Consequently, the reliability of the power supply section improves.

Moreover, according to the invention, inert gas or dry air circulates through the enclosed space portion, so that the reliability of the section for power supply to the vibrator further improves.

In the invention, it is preferable that the internal pressure of the enclosed space portion is higher than the pressure of the cleaning solution which is supplied to the nozzle and is ejected therefrom.

According to the invention, the pressure of the enclosed space portion is made higher than the pressure of the cleaning solution ejected from the nozzle. This ensures that the enclosed space portion is protected against intrusion of gas or liquid from outside.

Moreover, according to the invention, by increasing the pressure of the enclosed space portion, it is possible to prevent intrusion of gas or liquid from outside without fail.

In the invention, it is preferable that, in each of the ultrasonic vibration units, the vibrator and the power supply member are fastened to the casing constituting the enclosed space portion by screws and are thus detached therefrom with ease.

According to the invention, in each of the ultrasonic vibration units, the vibrator and the power supply member are fastened to the casing constituting the enclosed space portion by screws and are thus detached therefrom with ease. This helps reduce the time required for maintenance.

Moreover, according to the invention, the vibrator and the power supply member are fastened to the enclosed space portion by screws and are thus detached therefrom with ease, thereby facilitating maintenance.

In the invention, it is preferable that the ultrasonic vibration in use has a frequency within a range of 400 kHz to 2 MHz.

According to the invention, an ultrasonic wave having a frequency within a range of high frequencies is applied to the cleaning solution, so that the material to be cleaned is cleaned with efficiency.

Moreover, according to the invention, the vibrator gives an ultrasonic wave to the cleaning solution in an ultrasonic wave band of relatively high frequency, so that the material to be cleaned is cleaned with efficiency.

In the invention, it is preferable that opening portions of both end nozzles arranged in the widthwise direction are located so that the target material to be cleaned is interposed between the both nozzles, as viewed in the carrying direction.

According to the invention, a sufficient amount of cleaning solution is sprayed to even the widthwise end portion of the material to be cleaned, so that the target material is cleaned thoroughly.

Moreover, according to the invention, the opening portions of the nozzles are so arranged as to cover outside the widthwise portion of the material to be cleaned, so that even the edge portion of the material to be cleaned is cleaned thoroughly.

The invention further provides an ultrasonic cleaning method for cleaning both surfaces of a material to be cleaned, comprising the steps of:

placing the above-mentioned ultrasonic cleaning apparatus toward a side of one surface of a material to be cleaned so that cleaning solution applied with ultrasonic vibration is sprayed to the surface of the material to be cleaned; and

placing a cleaning solution supply nozzle toward a side of other surface of the material to be cleaned so that cleaning solution is sprayed to the other surface.

According to the invention, a plate-like material to be cleaned has its one surface cleaned with a jet of cleaning solution applied with an ultrasonic wave and has its other surface cleaned with a jet of cleaning solution, so that both surfaces of the material to be cleaned can be cleaned with efficiency.

Moreover, according to the invention, both surfaces of a plate-like material to be cleaned can be cleaned with efficiency.

The invention still further provides an ultrasonic cleaning method for cleaning a material to be cleaned, comprising the step of:

placing the above-mentioned ultrasonic cleaning apparatus above a to-be-cleaned surface of a material to be cleaned so that cleaning solution applied with an ultrasonic vibration is sprayed to the material to be cleaned.

According to the invention, by placing the ultrasonic cleaning apparatus above the to-be-cleaned surface of the material to be cleaned, cleaning solution applied with an ultrasonic wave is ejected from above to below. This makes it possible to clean the surface of the material to be cleaned with efficiency.

Moreover, according to the invention, the top surface of the material to be cleaned can be cleaned from above to below with efficiency.

### BRIEF DESCRIPTION OF THE DRAWINGS

Other and further objects, features, and advantages of the invention will be more explicit from the following detailed description taken with reference to the drawings wherein:

FIG. 1 is a front sectional view schematically illustrating the structure of one embodiment of the ultrasonic cleaning apparatus of the invention;

FIG. 2 is a plan view of the ultrasonic cleaning apparatus shown in FIG. 1;

FIG. 3 is a front sectional view schematically illustrating the structure of another embodiment of the ultrasonic cleaning apparatus of the invention;

FIG. 4 is a front sectional view of a prior art ultrasonic cleaning apparatus;

FIG. 5 is a sectional view as taken along section line A-A of FIG. 4; and

FIG. 6 is a sectional view as taken along section line B-B of FIG. 4.

### DETAILED DESCRIPTION OF THE PREFERRED EMBODIMENTS

Now referring to the drawings, preferred embodiments of the invention are described below.

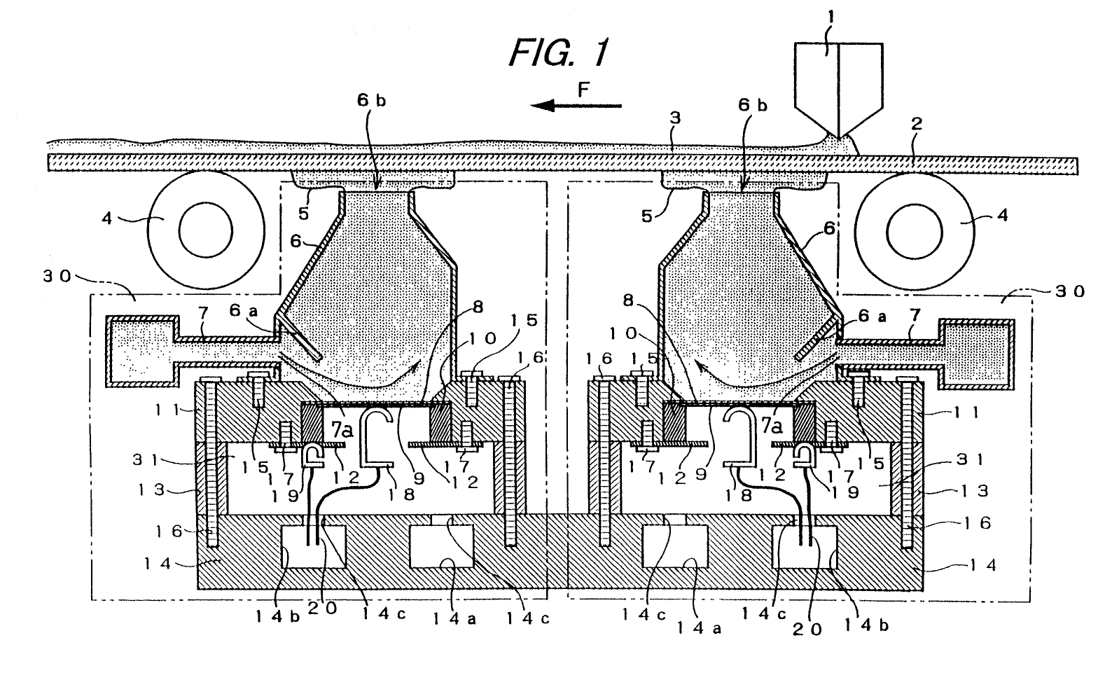

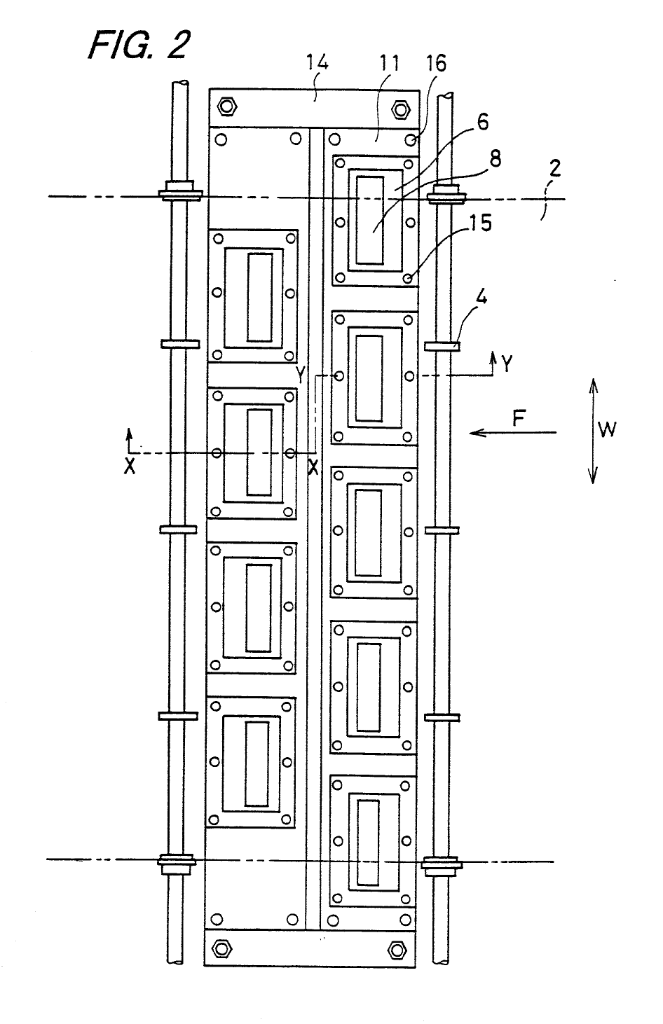

FIGS. 1 and 2 schematically illustrate the structure of one embodiment of the ultrasonic cleaning apparatus of the invention, with FIG. 1 showing the sectional configuration thereof as taken along section line X-X-Y-Y of FIG. 2, and FIG. 2 showing the plane configuration thereof.

As shown in FIG. 1, in the ultrasonic cleaning apparatus of the embodiment, a cleaning solution supply nozzle 1 supplies cleaning solution 3 to a to-be-cleaned surface of a glass substrate 2 to be cleaned for use in a liquid crystal display apparatus. The glass substrate 2 is carried by a carrier roller 4 in a carrying direction F, i.e., in a left-hand direction as viewed in the figure. On the bottom-surface side of the glass substrate 2 are disposed nozzles 6 for jetting cleaning solution 5 applied with an ultrasonic wave, the nozzles 6 being spaced in two rows in a direction in which the glass substrate 2 is carried (the carrying direction).

The nozzles 6; a cleaning solution duct 7; a vibration plate 8; a vibrator 9; a holding member 10; a fixing member 11; a rectangular plate material 12; and an intermediate member 13 are each attached to a platform 14 by bolts 15, 16, and 17, and the like. The surface of the vibrator 9 makes contact with a power supply member 18. The back-surface side of the vibrator 9 makes electrical contact with a power supply member 19 via the holding member 10 and the rectangular plate material 12. The power supply members 18 and 19 are supplied with high-frequency power through a wire 20 so as for the vibrator 9 to generate an ultrasonic wave. The constituent components including: the nozzles 6; the cleaning solution duct 7; the vibration plate 8; the vibrator 9; the holding member 10; and the power supply members 18 and 19, and in addition the components used for mounting the above-mentioned components including: the fixing member 11; the rectangular plate material 12; the intermediate member 13; the platform 14; and the bolts 15, 16, and 17 constitute an ultrasonic vibration unit 30.

As shown in FIG. 2, the ultrasonic vibration units 30 are arranged in two rows in a widthwise direction W orthogonal to acarryingdirectionFfortheglasssubstrate2. Specifically, the ultrasonic vibration units 30 are arranged in a staggered configuration so that a certain ultrasonic vibration unit 30 of one row is located toward a substantially central portion of two adjacent ultrasonic vibration units 30 of the other row. The nozzle 6 has a rectangular-shaped opening portion, the opening portion having its shorter side aligned with the carrying direction F of the glass substrate 2 and having its longer side aligned with the widthwise direction W orthogonal to the carrying direction F of the glass substrate 2. Inside each of the nozzles 6 is disposed the vibration plate 8. As shown in FIG. 1, the vibrator 9 is attached to each of the vibration plates 8 so as to pair up therewith.

Note that, in FIG. 2, although the number of the nozzles 6 of each row is larger on the upstream side than on the downstream side with respect to the carrying direction F of the glass substrate 2, even though the number of the nozzles 6 located on the upstream side is equal to or smaller than that of the nozzles 6 located on the downstream side, substantially the same cleaning effects are obtained. Moreover, the total number of the nozzles 6 is determined in accordance with the widthwise (W) dimension of the material to be cleaned. That is, the larger the widthwise (W) dimension of the material to be cleaned, the larger the total number of the nozzles 6 is required.

As shown in FIG. 1, the vibrators 9 are individually fixed to their respective vibration plates 8 so as to pair up therewith. The nozzles 6 are also individually fastened onto the fixing member 11 with the bolt 15. Inside the base-end-side portion of the nozzle 6 is provided a projection piece 6a extending in the widthwise direction W of the nozzle 6. The projection piece 6a has its one end connected to the intermediate portion of the nozzle 6 and has its other end extended toward the vibration plate 8. At the midpoint between the junction of the projection piece 6a and the nozzle 6 and the vibration plate 8 are provided a plurality of jets 7a communicating with the cleaning solution duct 7. The projection piece 6a serves to guide the cleaning solution 5 supplied by the jets 7a so that it travels toward the vibration plate 8 to which the vibrator 9 is fixed and flows convectively within the nozzle 6. On the front-end side of the nozzle 6 is formed a nozzle opening 6b. On the surface of the vibrator 9 is formed an electrode portion made of electrically conductive metal, such as gold (Au) or silver (Ag). The vibrator 9 is, at its outer edge, held by the holding member 10. The holding member 10 is fitted into a recess provided in the fixing member 11 so as to nip the vibration plate 8. By screw-fitting the base-end sides of a plurality of rectangular plate materials 12 to the fixing member 11 with the bolts 17, the holding member 10 is retained on the front-end side of the rectangular plate material 12.

The power supply member 18, made of a spring material, for supplying high-frequency power from the wire 20 makes elastic contact with one electrode portion of the vibrator 9. The power supply member 19 makes elastic contact with the holding member 10 and makes electrical contact with the other electrode portion of the vibrator 9 through the vibration plate 8 and the holding member 10. The power supply members 18 and 19 are supplied with high-frequency power from an oscillation circuit (not shown) through the wire 20. In this way, the current supplied passes through the power supply members 18 and 19. The power supply members 18 and 19 are retained within an enclosed space portion 31 surrounded by a casing including the vibrator 9, the holding member 10, the fixing member 11, the intermediate member 13, and the platform 14. By fastening the fixing member 11 and the intermediate member 13 onto the platform 14 with the bolt 16, the enclosed space portion 31 is brought into an airtight state. Note that, to make the enclosed space portion 31 fluid-tight, a sealing member needs to be provided for each of the junctions between the constituent components. However, for the sake of simplicity, the illustration thereof is omitted.

The platform 14 has an air supply path 14a for supplying air to the enclosed space portion 31. The air supply path 14a is arranged parallel to the widthwise direction and is substantially hairpin-shaped in part. Inside the platform 14 is also formed a wire-laying path 14b. The wire-laying path 14b is provided to allow passage of the wire 20. The wire 20 has its base end connected to the oscillation circuit. The air supply path 14a and the wire-laying path 14b are each provided with an air supply and exhaust opening 14c communicating with the enclosed space portion 31. Thus, by supplying inert gas or dry air from the apparatus to the air supply path 14a, and allowing the gas (or air) to be discharged from the wire-laying path 14b, the enclosed space portion 31 is put under inert gas atmosphere or dry air atmosphere. As a result, electrical contact is established without fail between the power supply member 18 and the electrode surface of the vibrator 9, and between the power supply member 19 and the holding member 10. This helps prevent deterioration in the quality of the constituent components due to oxidation. Note that it is also possible to run the wire 20 through the air supply path 14a so as to establish connection between the oscillation circuit and the power supply members 18 and 19. Moreover, by making the pressure of the cleaning solution 5, which is supplied to the nozzle 6 and is ejected therefrom, higher than the pressure of the enclosed space portion 31, the enclosed space portion 31 is protected against intrusion of gas or liquid from outside.

As shown in FIG. 2, in this embodiment, in order for the LCD glass substrate 2 to be wholly and evenly irradiated with an ultrasonic wave of sufficient intensity in the widthwise direction W orthogonal to the carrying direction, the nozzle openings 6b are arranged in two rows so that the vibration width of the vibrator 9 and the carrying-directional width of the glass substrate 2 overlap one another. This enables the entire glass substrate 2 to be cleaned thoroughly. Moreover, the ultrasonic wave application range is made larger than the carrying-directional width of the glass substrate 2 so that even the end face of the glass substrate 2 is cleaned properly. Thus, more reliable cleaning effect can be attained with ease. Further, the ultrasonic wave in use has a frequency within a range of 400 kHz to 2 MHz. This makes it possible to clean the material to be cleaned with high efficiency.

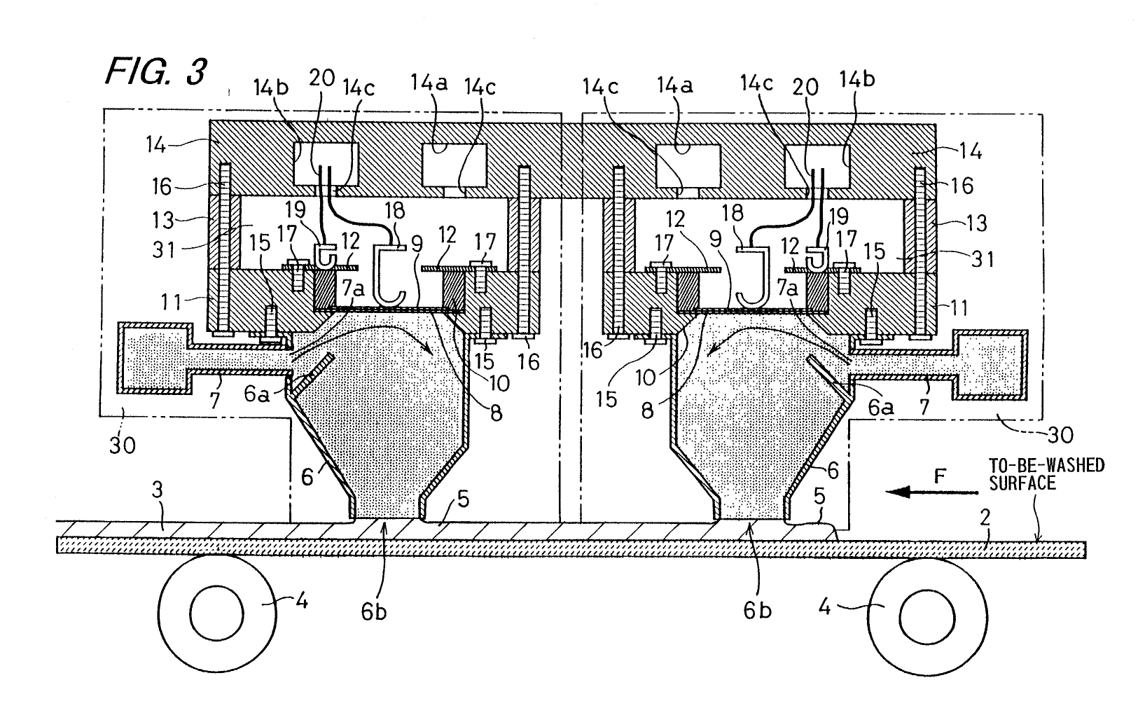

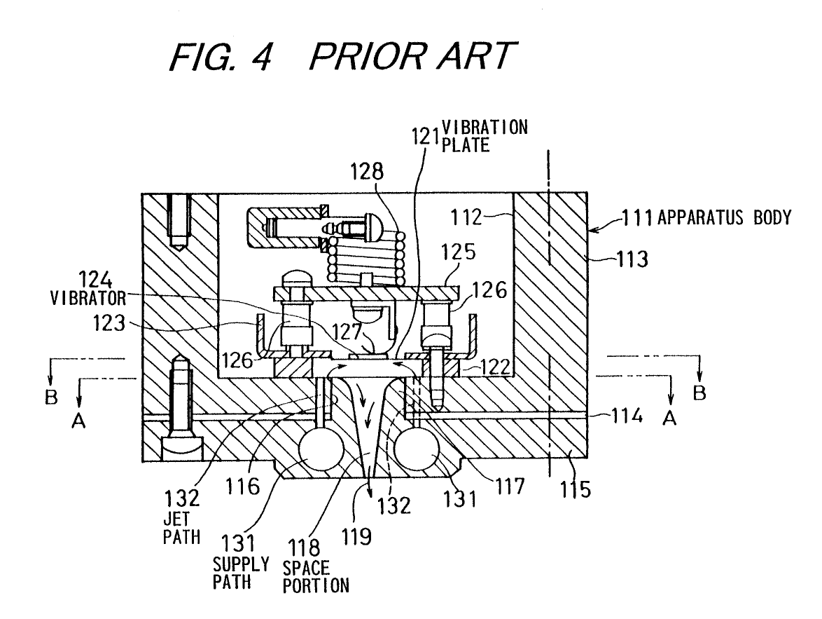

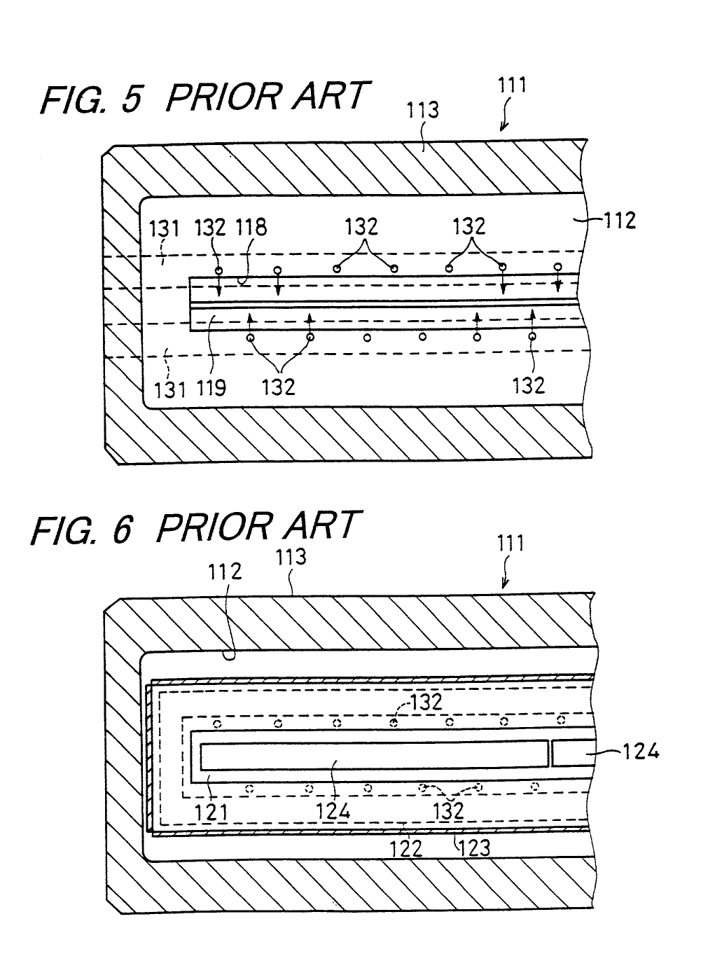

Note that the above-stated ultrasonic cleaning apparatus is so configured that the bottom-surface side, i.e., the to-be-cleaned surface, of the LCD glass substrate 2 is sprayed with a jet of the cleaning solution 5 applied with an ultrasonic wave generated by the vibrator 9, and the top surface of the glass substrate to be cleaned is separately sprayed with a jet of the cleaning solution 3 supplied from the cleaning solution supply nozzle 1. However, the invention is not limited to this embodiment. For example, FIG. 3 is a front sectional view schematically illustrating the structure of another embodiment of the ultrasonic cleaning apparatus of the invention. As shown in FIG. 3, the ultrasonic cleaning apparatus is illustrated upside down with respect to the structure of the above-stated embodiment. That is, the ultrasonic cleaning apparatus may be arranged above the LCD glass substrate 2 so that a jet of cleaning solution applied with an ultrasonic wave is sprayed to the to-be-cleaned surface. Alternatively, as still another embodiment of the invention, the ultrasonic cleaning apparatus may be arranged toward both sides, namely, the top and back surfaces, of the glass substrate 2 to be cleaned so that both surfaces thereof are cleaned concurrently. Moreover, the ultrasonic cleaning apparatus embodying the invention serves not only to clean the glass substrate 2, but also to clean a semiconductor wafer or the like. Further, in a case where a plate-like material is subjected to cleaning, the target material may be arranged with its to-be-cleaned surface perpendicular or inclined with respect to the horizontal plane. In this case, a jet of cleaning solution applied with an ultrasonic wave is sprayed to one or both surfaces of the target material to be cleaned. Still further, a single to-be-cleaned surface may be cleaned by the combination use of cleaning solution applied with an ultrasonic wave and cleaning solution free from ultrasonic wave.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An ultrasonic cleaning apparatus in which ultrasonic vibration is applied to at least part of cleaning solution, and, by a piece-by-piece method, a material to be cleaned is cleaned with the cleaning solution while being carried in a predetermined direction, the ultrasonic cleaning apparatus comprising:
a plurality of ultrasonic vibration units each having a nozzle elongated in one direction, for spraying cleaning solution from the nozzle to the material to be cleaned, the cleaning solution being applied with ultrasonic vibration by a vibration plate to which a vibrator is fixed so as to pair up therewith,
wherein the plural ultrasonic vibration units are arranged in two rows in a widthwise direction orthogonal to the carrying direction, and also so arranged that a certain ultrasonic vibration unit of one row is located toward a substantially center of two adjacent ultrasonic vibration units of the other row.

2. The ultrasonic cleaning apparatus of claim 1,
wherein the ultrasonic vibration unit includes:
a holding member for holding the vibrator;
a power supply member for supplying a high frequency power to the vibrator by making elastic contact with an electrode of the vibrator and the holding member;
a wire for supplying the power to the power supply member; and
a casing having an enclosed space portion formed therein for accommodating the vibrator, the power supply member, and the wire, and
wherein the nozzle with a predetermined dimensional width is disposed adjacent to the vibration plate, the nozzle including a projection piece for supplying cleaning solution through which ultrasonic vibration is transmitted to the vibration plate and for convectively circulating the cleaning solution.

3. The ultrasonic cleaning apparatus of claim 2,
wherein, in each of the ultrasonic vibration units arranged, the casing includes:
a cleaning solution supply path for supplying cleaning solution to the nozzle;
an air supply path for supplying air to the enclosed space portion; and
a wire-laying path for laying down the wire required to supply the power to the vibrator.

4. The ultrasonic cleaning apparatus of claim 3,
wherein, in each of the ultrasonic vibration units, the casing is provided with an opening portion for providing communication among the enclosed space portion, the air supply path, and the wire-laying path,
and wherein, by circulating inert gas or dry air, the power supply member, the wire, and the vibrator are put under inert gas atmosphere or dry air atmosphere.

5. The ultrasonic cleaning apparatus of claim 4,
wherein the internal pressure of the enclosed space portion is higher than the pressure of the cleaning solution which is supplied to the nozzle and is ejected therefrom.

6. The ultrasonic cleaning apparatus of claim 2,
wherein, in each of the ultrasonic vibration units, the vibrator and the power supply member are fastened to the casing constituting the enclosed space portion by screws and are thus detached therefrom with ease.

7. The ultrasonic cleaning apparatus of claim 1,
wherein the ultrasonic vibration in use has a frequency within a range of 400 kHz to 2 MHz.

8. The ultrasonic cleaning apparatus of claim 1,
wherein opening portions of both end nozzles arranged in the widthwise direction are located so that the target material to be cleaned is interposed between the both nozzles, as viewed in the carrying direction.

9. An ultrasonic cleaning method for cleaning both surfaces of a material to be cleaned, comprising the steps of:
placing the ultrasonic cleaning apparatus of claim 1 toward a side of one surface of a material to be cleaned so that cleaning solution applied with ultrasonic vibration is sprayed to the surface of the material to be cleaned; and
placing a cleaning solution supply nozzle toward a side of other surface of the material to be cleaned so that cleaning solution is sprayed to the other surface.

10. An ultrasonic cleaning method for cleaning a material to be cleaned, comprising the step of:
placing the ultrasonic cleaning apparatus of claim 1 above a to-be-cleaned surface of a material to be cleaned so that cleaning solution applied with an ultrasonic vibration is sprayed to the material to be cleaned.
